(19) United States
(12) Patent Application Publication
(10) Pub. No.: US 2008/0186729 A1
(43) Pub. Date: Aug. 7, 2008

(54) Vehicle headlight mounting assembly

(76) Inventor: Kenneth Edward Madden, Andover, MN (US)

Correspondence Address: John M. Weyrauch;DICKE, BILLIG & CZAJA, PLLC, Suite 2250, 100 South Fifth Street, Minneapolis, MN, 55402, US

(21) Appl. No.: 11/701,043

(22) Filed: Feb. 1, 2007

(51) Int. Cl. B62J 6/02

(52) U.S. Cl. 362/546; 362/549

(57) ABSTRACT

A mounting assembly configured to attach a headlight to a vehicle includes a mounting bracket and a support member attachable to the mounting bracket. The mounting bracket includes a first portion and a second portion extending from the first portion. The first portion is configured for attachment to the vehicle, and the second portion includes a major surface defining a longitudinally curved saddle. The support member includes a base configured for attachment to a housing of the headlight and a curved seat configured to couple to the curved saddle of the mounting bracket. In this regard, the curved saddle and the curved seat are configured to have substantially complementary curvature such that the curved seat nests relative to the curved saddle. Longitudinal movement of the curved seat of the support member relative to the curved saddle of the mounting bracket permits a height adjustment of the headlight. A connector extends through an elongate bore in the second portion of the mounting bracket and connects to the support member to securely fix the relative positions of the support member and the mounting bracket.

### BACKGROUND

The present invention generally relates to vehicle headlight mounting assemblies, and more particularly to a mounting assembly for a motorcycle headlight. Known headlight mounting assemblies for motorcycles are prone to movement of the headlight from a desired position due to the weight of the headlight and vibration from the motorcycle engine and road conditions. The present invention is an improved mounting assembly for a vehicle headlight that is resistant to movement from such vibration.

### SUMMARY OF THE INVENTION

The present invention is a mounting assembly configured to attach a headlight housing to a vehicle. The mounting assembly comprises a mounting bracket configured for attachment to a vehicle. The mounting bracket comprises a first portion having a first side, a second side and a length. The first side of the first portion defines a curved surface along the length. The first portion further comprises an elongate bore that communicates between the first and second sides and extends generally along the length. The mounting assembly further comprises a support member which includes a base having a first side and a second side. The first side of the base is configured for attachment to the headlight housing. The second side of the base is configured to define a curved surface. The curved surface of the base has a complimentary radius of curvature as the curved surface of the first portion of the mounting bracket. The mounting assembly further comprises means for connecting the support member to the mounting bracket so as to allow relative movement between the support member and the mounting bracket and so as to fix the relative position of the support member to the mounting bracket.

### BRIEF DESCRIPTION OF THE DRAWINGS

FIG. 1 is a perspective exploded view of a vehicle headlight housing and a mounting assembly according to one embodiment of the present invention;

FIG. 2 is a side view of a mounting bracket of the mounting assembly shown in FIG. 1;

FIG. 3 is a perspective view of the mounting bracket shown in FIG. 2;

FIG. 4 is a perspective view of a support member of the mounting assembly shown in FIG. 1;

FIG. 5 is a longitudinal cross-sectional view of the support member shown in FIG. 4 coupled to a headlight housing as shown in FIG. 1 taken along line 5-5;

FIG. 6 is a bottom plan view of the headlight housing shown in FIG. 5; and

FIG. 7 is a perspective view of a vehicle headlight system mounted to a motorcycle according to one embodiment of the present invention.

### DETAILED DESCRIPTION

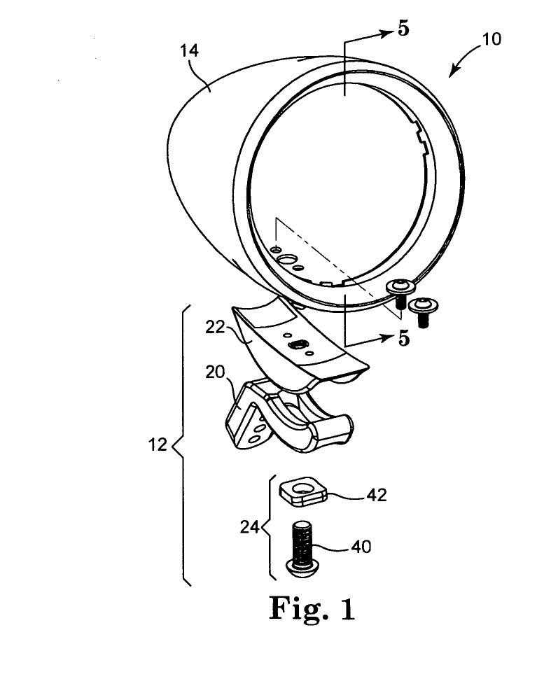

FIG. 1 is a perspective exploded view of a headlight 10 and a mounting assembly 12 configured for attaching headlight housing 10 to a vehicle according to one embodiment of the present invention. Headlight 10 generally includes a headlight housing 14 configured to enclose a lighting assembly (not shown). Mounting assembly 12 includes a mounting bracket 20 configured for attachment to a vehicle, a support member 22 configured to couple between headlight housing 14 and a portion of mounting bracket 20, and connector 24 configured to adjustably couple mounting bracket 20 and support member 22. In one embodiment, connector 24 comprises a bolt 40 and washer 42. In general, mounting bracket 20 defines a curved surface that is configured to receive a complementary curved surface of support member 22. As described in detail below, the complementary curved surfaces of the mating portions of mounting bracket 20 and support member 22 enables adjustment of headlight 10 to a desired stable orientation, that when secured in place, resists movement due to vibrations.

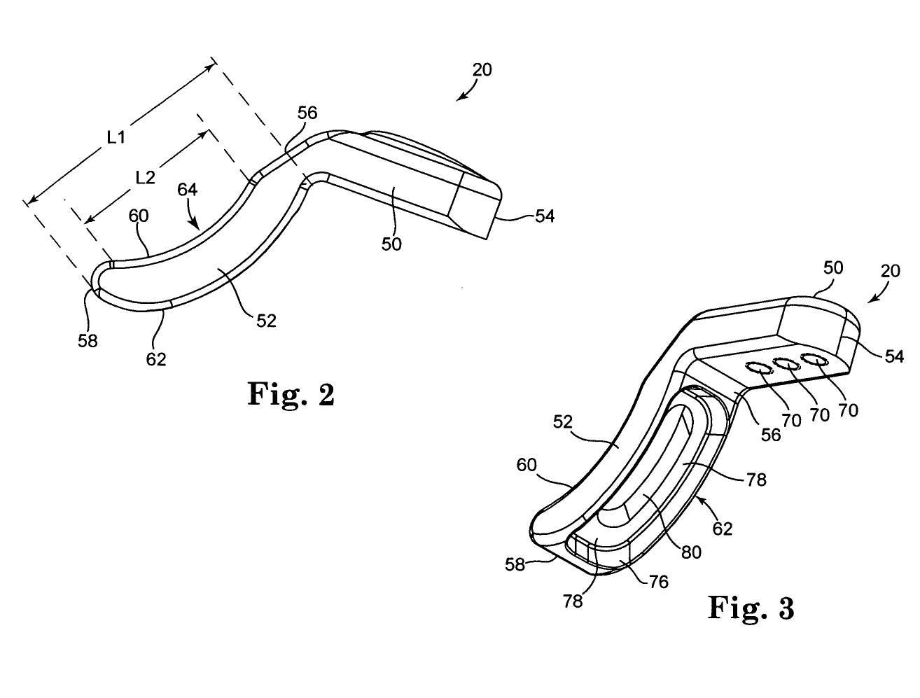

FIG. 2 is a side view of one embodiment of mounting bracket 20. Mounting bracket 20 includes a first portion 50 configured for attachment to a vehicle, and a second portion 52 configured to couple with support member 22 (FIG. 1). In one embodiment, first portion 50 extends in a first direction between a first end 54 and a neck 56, and second portion 52 extends in a second direction from neck 56 to a second end 58. The first and second directions' are selected according to the specific vehicle mounting environment. In one embodiment, second portion 52 extends at an angle relative to first portion 50, as illustrated in FIG. 2. The angle of second portion 52 relative to first portion 50 may vary according to the mounting environment for headlight 10 on a particular vehicle. For example, in another embodiment second major surface 62 may be substantially linear and second portion 52 is aligned linearly with first portion 50 to enable mounting bracket 20 to be coupled to a relatively flat surface, such as a fender of an automobile.

Second portion 52 of mounting bracket 20 extends between neck 56 and second end 58 over a length L1 and includes a first major surface 60 opposite a second major surface 62. The first major surface 60 defines a longitudinally curved saddle 64 having a length L2. In one embodiment, curved saddle 64 of first major surface 60 extends a majority of the length of second portion 52. Second major surface 62 of mounting bracket 20 is generally parallel to the first major surface 60. In alternative embodiments, second major surface 62 may be configured with other contours or shapes.

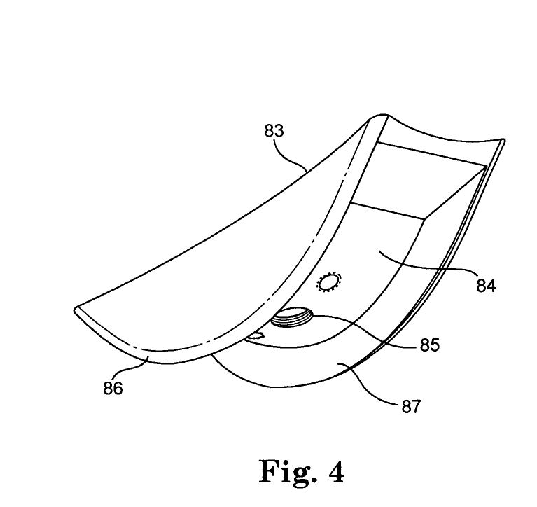

FIG. 3 is a perspective view of mounting bracket 20 illustrating an oblique view of first portion 50 and second major surface 62. As shown in FIG. 3, first portion 50 includes a plurality of bores 70 each configured to receive a fastener to couple first portion 50 to a vehicle. In one embodiment, bores 70 are threaded “blind” bores, i.e., bores that do not communicate entirely through first portion 50. Bores 70 are configured to receive a threaded bolt suited for attaching mounting bracket 20 to suitable structure of a vehicle.

In one embodiment, second portion 52 is configured to define a cavity 76 that extends from the second surface 62 toward the first surface 60 along a majority of the length L1. Second portion 52 further includes elongate bore 80 that communicates between the first major surface 60 and the cavity 76. The through-bore 80 has a length generally equal to the length L2 of the curved saddle 64. A floor of cavity 76 defines a curved perimeter shoulder 78 around elongate bore 80 that is generally parallel to the curved saddle 64. Shoulder 78 is configured to frictionally engage a head of connector 24, e.g., washer 42, when bolt 40 extends through the elongate bore 80 and is threaded into support member 22.

FIG. 4 is a perspective view of support member 22. In one embodiment, support member 22 includes a first surface defining a generally planar base 83 and a second surface defining a curved seat 84 opposite of base 83. In general, base 83 is configured to mate with headlight housing 14 (FIG. 1), and curved seat 84 is configured to nest within curved saddle 64 of mounting bracket 20 (FIG. 2). Curved seat 84 of support member 22 includes a threaded bore 85 configured to receive bolt 40 (FIG. 1). Curved seat 84 defines a convex curve that is complementary in curvature to the concave curve of saddle 64 (FIG. 2). In this manner, curved seat 84 is configured to nest within curved saddle 64, and move longitudinally relative to curved saddle 64.

In one embodiment, support member 22 additionally includes a first side wall 86 coupled to a first side of base 83 and a second side wall 87 coupled to a second side of base 83. Side walls 86, 87 extend from base 83 in a direction common with the curved seat 84 and are sized and shaped to straddle opposing sides of the second portion 52 of mounting bracket 20 when the curved seat 83 is in contact with the curved saddle 64. When present, side walls 86, 87 assist to laterally restrain movement of headlight housing 14 relative to mounting bracket 20.

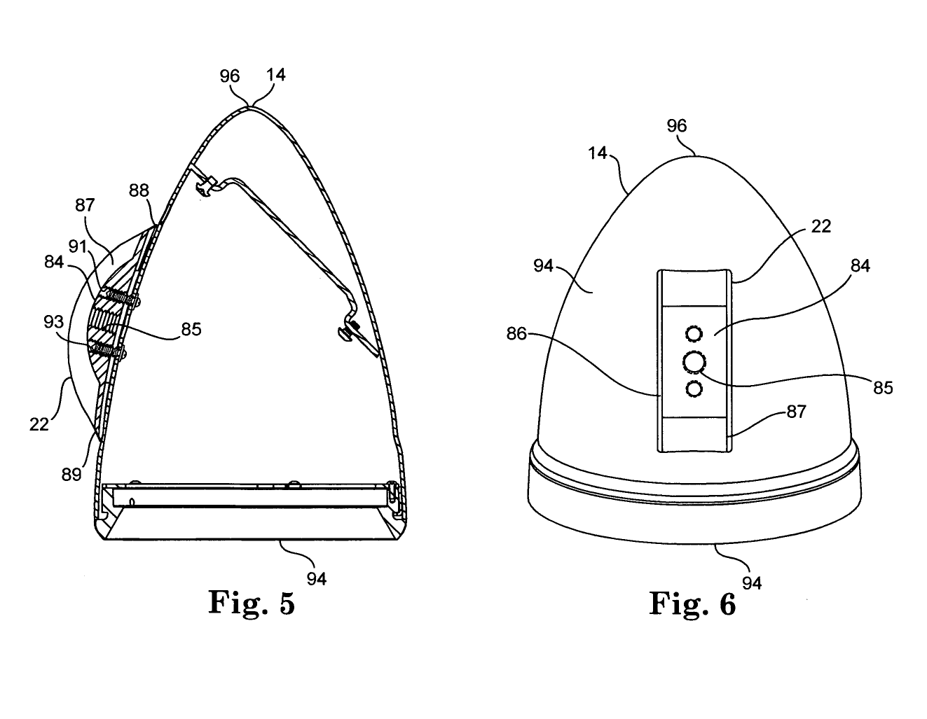

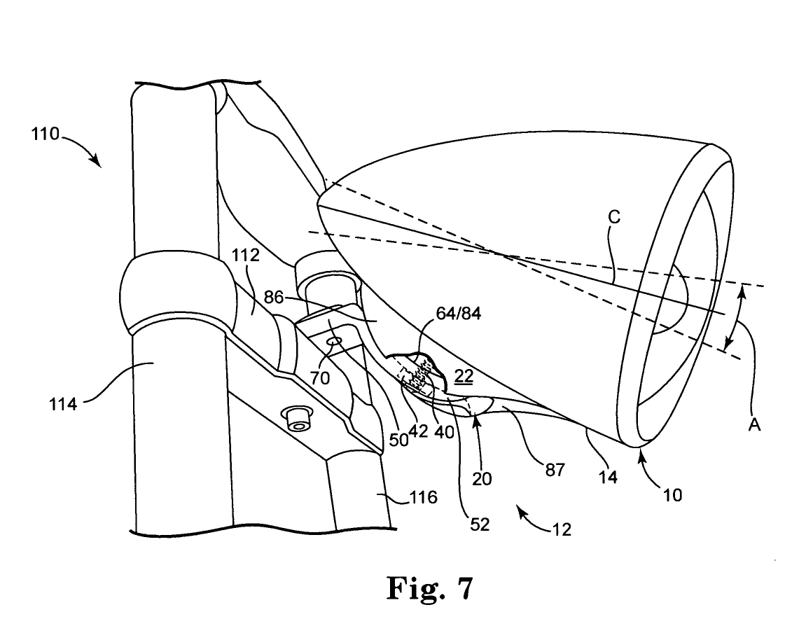

FIG. 5 is a cross-sectional view of headlight housing 14, and FIG. 6 is a bottom plan view of headlight housing 14. As shown in FIGS. 5 and 6, threaded bore 85 is centrally located relative to opposing ends 88, 89 of support member 22. Support member 22 further includes a pair of threaded bores 91, 93 adjacent to bore 85. Bores 91, 93 align with complimentary openings in headlight housing 14 for receiving connectors to secure support member 22 to the headlight housing 14. In alternative embodiments, support member 22 is attached to headlight housing 14 by other means, such as welding, adhesive or other mechanical means. Further, support member 22 may be integrally formed into headlight housing 14. Support member 22 is oriented on a longitudinal axis of housing 14 with the curved seat 84 extending between the front end 94 and the rear end 96 of housing 14.

FIG. 7 is a partial perspective view of headlight 10 and mounting assembly 12 mounted on a front fork assembly 110 of a motorcycle. As shown in FIG. 7, the first portion 50 of mounting bracket 20 is secured to a cross-support 112 connected between tubes 114 and 116 of the front fork assembly 110. In one embodiment, first portion 50 of mounting bracket 20 is centered between tubes 114, 116 and connected to cross-support 112 with a suitable connector via one or more of bores 70. Support member 22 is coupled to headlight housing 14, and curved seat 84 of support member 22 is supportively nested within curved saddle 64 of mounting bracket 20. Bolt 40 is inserted through the elongate bore 80 of the second portion 52 and threaded into bore 85 of the support member 22, with washer 42 positioned within cavity 76. When bolt 40 is loosened, headlight housing 14 is free to move in an arc relative to the curvature of curved seat 64 of mounting bracket 20. In this manner, an adjustable forward projection angle A relative to central axis C of headlight 10 is provided. The extent of adjustment is a function of the length and radius of curvature of second portion 52. When a desired forward projection angle A for light 30 is achieved, bolt 40 is tightened to frictionally secure the curved seat 84 relative to the curved saddle 64 and thereby set a desired position of headlight 10.

The complementary curvature of curved saddle 64 and curved seat 84 enables curved seat 84 to nest within and be fully supported by saddle 64. In particular, the length L2 of curved saddle 64 supports a length of curved seat 84, such that headlight housing 14 is stabilized relative to mounting bracket 20 even in the presence of vehicle vibration. In one embodiment, the length L2 of curved saddle 64 supports substantially an entirety of curved seat 84 to minimize vibratory displacement of headlight 10 coupled to support member 22. Cavity 76 and slot 80 enable connector 24 to be loosened without being fully removed from support member 22, which permits headlight housing 14/support member 22 to be rotated in an arc relative to mounting bracket 20 for adjustment of forward projection angle A of headlight 10.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of vehicle headlight mounting assemblies beyond the specific embodiments discussed herein. For example, although curved saddle 64 is generally illustrated as concave and curved seat 84 is generally illustrated as convex, it is to be understood that embodiments of the invention provide for other surface shapes, such as a convex shape for curved saddle and a concave shape for curved seat. The complementary curvature of curved saddle 64 and curved seat 84 is configured to enable mounting bracket 20 and support member 22 to nest together, and to enable curved seat 84 and curved saddle 64 to slide relative to one another for adjustment of headlight housing 14 (FIG. 7). Therefore, it is intended that this invention be limited only by the claims and the equivalents thereof.

What is claimed is:

1. A mounting assembly configured to attach a headlight housing to a vehicle, the mounting assembly comprising:
a mounting bracket configured for attachment to a vehicle, the mounting bracket comprising a first portion having a first side, a second side and a length, the first side of the first portion defining a curved surface along the length, the first portion further comprising an elongate bore communicating between the first and second sides and extending generally along the length;
a support member including a base having a first side and a second side, the first side configured for attachment to the headlight housing, the second side configured to define a curved surface, the curved surface of the base having a complimentary radius of curvature as the curved surface of the first portion of the mounting bracket; and
means for connecting the support member to the mounting bracket so as to allow relative movement between the support member and the mounting bracket and so as to fix the relative position of the support member to the mounting bracket.

2. The mounting assembly of claim 1, wherein the mounting bracket further comprises a second portion, the second portion connected to and extending from the first portion, the second portion configured for attachment to the vehicle.

3. The mounting assembly of claim 1, wherein the curved surface of the base comprises a threaded bore, and wherein the means for connecting comprises a threaded connector extending through the elongate bore and being threadably connected to the threaded bore of the base curved surface.

4. The mounting assembly of claim 3, wherein the second side of the mounting bracket first portion is configured to define a cavity that extends from the second side toward the first side, the cavity having a width greater than that of the elongate bore, the cavity defining a perimeter shoulder around and normal to the bore that is recessed relative to the second side of the mounting bracket first portion, wherein the threaded connector comprises a head that seats against the shoulder when the support member is secured to the mounting bracket.

5. A vehicle headlight system comprising:
a headlight housing having a front end, a rear end and an outer surface;
a support member including a first side and a second side, the first side comprising a generally planar base, the second side comprising a curved surface, the curved surface extending between first and second ends of the support member, the base being connected to the outer surface of the headlight housing between the front end and the rear end, the support member including a bore between the curved surface and the base;
a mounting bracket including a first portion and a second portion extending from the first portion, the first portion configured to be coupled to a vehicle and the second portion including a first end, a second end, a first major surface defining a longitudinally curved saddle and a second major surface, the second portion further including an elongate bore extending between the first and second major surfaces, the elongate bore having a length extending generally between the first and second ends of the second portion; and
a connector extending through elongate bore of the second portion of the mounting bracket and connecting to the bore of the support member, wherein the curved surface of the support member nests relative to the longitudinally curved saddle, the support member being longitudinally moveable relative to the curved saddle along the length of the elongate bore when the connector is engaging the bore of the support member, the connector configured to secure the curved surface relative to the curved saddle to maintain a desired position of the headlight housing.
